(19) United States
(12) Patent Application Publication
(10) Pub. No.: US 2025/0289131 A1
(43) Pub. Date: Sep. 18, 2025

(54) SYSTEM, METHOD AND NON-TRANSITORY COMPUTER-READABLE STORAGE DEVICE FOR AUTONOMOUS NAVIGATION OF AUTONOMOUS ROBOT

(71) Applicant: Dubai Future Foundation, Dubai (AE)

(72) Inventors: Tarek Taha, Dubai (AE); Chien Ming, Dubai (AE); Layth Mahdi, Dubai (AE)

(73) Assignee: Dubai Future Foundation, Dubai (AE)

(21) Appl. No.: 19/079,919

(22) Filed: Mar. 14, 2025

Related U.S. Application Data
(60) Provisional application No. 63/565,879, filed on Mar. 15, 2024.

(51) Int. Cl. B25J 9/16; G06T 7/12; G06T 7/13; G06V 10/426; G06V 10/44; G06V 10/764

(52) U.S. Cl. CPC B25J 9/1664; B25J 9/1697; G06T 7/12; G06T 7/13; G06V 10/426; G06V 10/44; G06V 10/764

(57) ABSTRACT

A system and method of autonomously navigating an autonomous robot is described. The described method involves creating a topological mapping of an area of environment around a location of the mobile robot; identifying at least one pathway around the location; and locally constraining a motion of the mobile robot based on the topological mapping and the identified at least pathway. The method expects inaccuracies in the localization to happen within an acceptable range and mitigates these errors by locally constraining the motion of the robot or vehicle to what is defined safe upon an analysis of data perceived through one or more robot sensors.

### CROSS-REFERENCE TO RELATED APPLICATIONS

This application claims the benefit of U.S. Provisional Patent Application Ser. No. 63/565,879, filed Mar. 15, 2024, entitled “SYSTEM AND METHOD FOR AUTONOMOUS NAVIGATION OF AUTONOMOUS ROBOT”, the content of which is incorporated herein by reference in its entirety.

### TECHNICAL FIELD

The present description relates to a system, method and non-transitory computer-readable storage device for autonomous navigation of an autonomous robot, such as a last-mile delivery robot.

### BACKGROUND

Mobile robots are becoming increasingly popular in a variety of environments, including last-mile delivery. The growth of e-commerce has led to a high demand for diverse last-mile delivery methods. Last-mile delivery is the final stage of the e-commerce supply chain, where goods and packages are physically delivered to customers. Autonomous last-mile delivery, which uses self-driving robots to deliver goods and packages, is a rapidly growing field with the potential to revolutionize the delivery industry.

To enhance a robot's ability to navigate autonomously, precise localization and navigation is important. However, achieving this in complex urban environments or areas with dense vegetation can often be very challenging. Traditional methods require a dense mapping of the operational environment a priori, which can be delicate and sensitive to changes in the robot's surroundings. For example, the localization process can involve SLAM (Simultaneous Localization and Mapping) relying on Light Detection and Ranging (LiDAR) or other high definition sensors to estimate the proximity of the robots directly or indirectly to the surrounding objects and obstacles. Such devices can often be costly and occupy a lot of space.

There is therefore a need to provide an alternative and/or improved system and method for autonomous navigation of an autonomous robot.

### SUMMARY

The following presents a summary of some aspects or embodiments of the disclosure in order to provide a basic understanding of the disclosure. This summary is not an extensive overview of the disclosure. It is not intended to identify key or critical elements of the disclosure or to delineate the scope of the disclosure. Its sole purpose is to present some embodiments of the disclosure in a simplified form as a prelude to the more detailed description that is presented later.

In accordance with one aspect of the present disclosure, a method of autonomous navigation of a mobile robot is described. The method comprises creating a topological mapping of an area of environment around a location of the mobile robot; identifying at least one pathway around the location; and locally constraining a motion of the mobile robot based on the topological mapping and the identified at least pathway.

In some embodiments, the method further comprises receiving data from one or more cameras and sensors attached to the mobile robot, wherein the one or more cameras and sensors comprise one or more of a monocular camera, a wheel odometry sensor, an inertial measurement unit (IMU) and a red, green, and blue (RGB) camera.

In some embodiments, creating the topological mapping of the environment comprises receiving data from a Real-Time Kinematic (RTK) Global Positioning System (GPS).

In some embodiments, the topological mapping of the area of environment comprises a network of interconnected landmarks includes one or more landmarks and a relationship between the one or more landmarks.

In some embodiments, creating the topological mapping of the environment further comprises: extracting features from images captured by one or more cameras and sensors; matching the extracted features across different images to establish connections between landmarks; and generating a topological graph using the matched features and the connections between the landmarks.

In some embodiments, locally constraining the motion of the mobile robot comprises defining a safe criteria for robot motion commands based on the topological mapping and the identified at least pathway.

In some embodiments, identifying the at least one pathway further comprises semantic segmenting an image captured by one or more cameras and sensors to classify each pixel in the image into a corresponding semantic category; detecting edges in the segmented image to identify continuous lines and boundaries; and combining the segmented image and the detected edges to identify the at least one pathway within the image as a route for navigation.

In some embodiments, the method further comprises improving an accuracy and robustness of the topological mapping and pathway identification using machine learning techniques.

In accordance with another aspect of the present disclosure, a system for autonomous navigation of an autonomous robot is described. The system comprises at least one hardware processor; and at least one non-transitory computer readable media that store instructions that when executed by the at least one hardware processor cause the at least one hardware processor to perform operations comprising: creating a topological mapping of an area of environment around a location of the mobile robot using data from one or more perception sensors; identifying at least one pathway around the location using the data from the one or more perception sensors; and locally constraining a motion of the mobile robot based on the topological mapping and the identified at least pathway.

In some embodiments, the one or more perception sensors comprise one or more of a monocular camera, a wheel odometry, an inertial measurement unit (IMU) and a red, green, and blue (RGB) camera.

In some embodiments, creating the topological mapping of the area of environment comprises receiving data from a Real-Time Kinematic (RTK) Global Positioning System (GPS).

In some embodiments, the topological mapping of the area of environment comprises a network of interconnected landmarks includes one or more landmarks and a relationship between the one or more landmarks.

In some embodiments, creating the topological mapping of the environment further comprises extracting features from images captured by the one or more perception sensors; matching the extracted features across different images to establish connections between landmarks; and generating a topological graph using the matched features and the connections between the landmarks.

In some embodiments, locally constraining the motion of the mobile robot comprises defining a safe criteria for robot motion commands based on analyzing the data from the one or more perception sensors.

In some embodiments, identifying the at least one pathway further comprises semantic segmenting an image captured by the one or more perception sensors to classify each pixel in the image into a corresponding semantic category; detecting edges in the segmented image to identify continuous lines and boundaries; and combining the segmented image and the detected edges to identify the at least one pathway within the image as a route for navigation.

In some embodiments, the operations further comprise improving an accuracy and robustness of the topological mapping and pathway identification using machine learning techniques.

In accordance with one aspect of the present disclosure, one or more non-transitory computer-readable storage devices comprising computer-executable instructions are described, wherein the instructions, when executed, cause one or more hardware processors to perform a method of autonomous navigation of a mobile robot, the method comprising creating a topological mapping of an area of environment around a location of the mobile robot; identifying at least one pathway around the location; and locally constraining a motion of the mobile robot based on the topological mapping and the identified at least pathway.

In some embodiments, creating the topological mapping of the environment further comprises extracting features from images captured by the one or more cameras and sensors; matching the extracted features across different images to establish connections between landmarks; and generating a topological graph using the matched features and the connections between the landmarks.

In some embodiments, identifying the at least one pathway further comprises: semantic segmenting an image captured by one or more cameras and sensors to classify each pixel in the image into a corresponding semantic category; detecting edges in the segmented image to identify continuous lines and boundaries; and combining the segmented image and the detected edges to identify the at least one pathway within the image as a route for navigation.

In some embodiments, locally constraining the motion of the mobile robot comprises defining a safe criteria for robot motion commands based on the topological mapping and the identified at least pathway.

### BRIEF DESCRIPTION OF THE DRAWINGS

These and other features of the disclosure will become more apparent from the description in which reference is made to the following appended drawings.

FIG. 1 is a block diagram of a system of automatous navigation of a mobile robot, according to one embodiment of the description;

FIG. 2 is a block diagram of the functions of the system of automatous navigation, according to one embodiment of the description;

FIG. 3 is a flow diagram of topological mapping, according to one embodiment of the description;

FIGS. 4A and 4B are examples of a topological map generated according to an embodiment of the present description;

FIG. 5 is a flow diagram of pathway identification, according to one embodiment of the description;

FIG. 6 is a flow diagram of a method of automatous navigation of a mobile robot, according to one embodiment of the description;

FIG. 7 is an illustration of the motion of a mobile robot implemented with topological mapping and walkway detection functions;

FIG. 8 is an illustration of the motion of a mobile robot without being implemented with topological mapping or walkway detection functions;

FIG. 9 is an illustration of the motions of FIGS. 6 and 7 overlapped for comparison; and

FIG. 10 is a flow diagram of a method of autonomous navigation of a mobile robot, according to some embodiments of the description.

### DETAILED DESCRIPTION

The following detailed description contains, for the purposes of explanation, various illustrative embodiments, implementations, examples and specific details in order to provide a thorough understanding of the disclosure. It is apparent, however, that the disclosed embodiments may be practiced, in some instances, without these specific details or with an equivalent arrangement. The description should in no way be limited to the illustrative implementations, drawings, and techniques illustrated below, including the exemplary designs and implementations illustrated and described herein, but may be modified within the scope of the appended claims along with their full scope of equivalents.

The present description discloses a system and method for autonomous navigation of an autonomous robot, such as a last-mile delivery robot or vehicle, using topological mapping and local domain restrictions.

As will be explained in more detail below, the present description introduces a novel approach to autonomously navigate an autonomous robot. Unlike commonly used methods that rely on dense a priori mapping of the environment for localization of the area where the robot will be deployed, various embodiments of the description rely on a simplified topological mapping of the environment performed during environmental surveying. The approach does not rely on perfect positioning through sensor fusion or map re-localization but expects inaccuracies in the localization to happen within an acceptable range. The approach further mitigates these errors by locally constraining the motion of the robot or vehicle to what is defined safe upon an analysis of data perceived through one or more robot sensors.

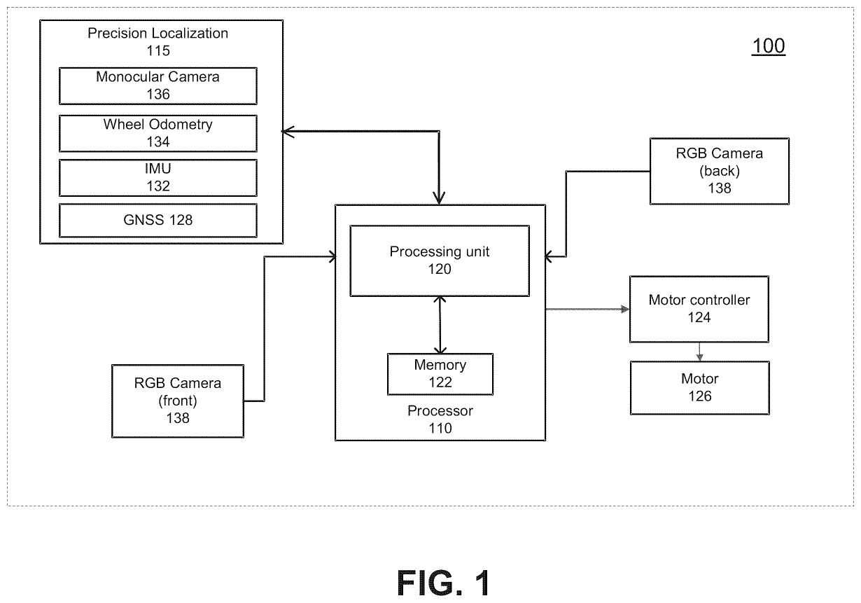

Embodiments are described below, by way of example only, with reference to FIGS. 1-10. Reference numerals have been referred to facilitate understanding and are not intended to limit the scope of the present invention in any manner.

FIG. 1 shows a system 100 of automatous navigation of a mobile robot, according to one embodiment of the description. The system 100 can be implemented on, attached to, or otherwise integrated into a mobile robot, such as a last-mile delivery robot or vehicle.

According to the embodiment of the description, the system 100 includes a processor 110 including one or more hardware processing units 120 and one or more hardware computer readable memory or memories 122. In some implementations, instructions stored in the memory/memories 122 may configure the one or more hardware processing units 120 to perform one or more of the functions discussed below to provide for autonomous navigation of the mobile robot. The processor 110 may further include interface(s) (not shown) provided for electronic communication between the one or more processing units 120, the one or more memory/memories 122, and other components of the system 100.

The system 100 may also include one or more motor controllers 124 coupled to the processor 110 for controlling motions of one or more motors 126 of the autonomous robot. It should be understood that the figure illustrates the one or more motor controllers 124 as separate from the processor 110 for illustration purposes, the motion control functions may be partially or wholly implemented within the processor 110.

The processing units 120, memories 122, the motor controllers 124 and/or various other components of the system may be operably connected via any interconnect technology, such as a bus. For example, the system 100 can be equipped with controller area network (CANBus) communication capabilities, facilitating comprehensive monitoring and control of the system 100.

The system 100 includes a precision localization module 115 connected to the processor 110 through a communication means including but not limited to an Ethernet hub (omitted). The precision localization module 115 can comprise multiple components and is adapted to provide data fused from various inputs and/or sensors.

In some embodiments, the precision localization module 115 comprises a global navigation satellite system (GNSS) unit 128. According to one embodiment of the description, the GNSS unit can be a Real-Time Kinematic (RTK) Global Positioning System (GPS), which is a high-precision GPS system that can provide centimetre-level accuracy. RTK GPS generally involves two GPS receivers: a base station and a rover. The base station is set up at a known location, and it sends correction signals to the rover; and the rover uses these correction signals to improve its accuracy. RTK GPS is more accurate than standard GPS because it can correct for errors caused by satellite clock errors, atmospheric interference, and multipath, which makes it particularly suitable for applications that require high-precision positioning.

According to various embodiments of the description, the precision localization module 115 can also comprise an inertial measurement unit (IMU) 132 for measuring the acceleration and orientation of an object. The IMU 132 can be composed of three accelerometers, three gyroscopes, and three magnetometers. The accelerometers are adapted to measure the object's acceleration in the x, y, and z directions; the gyroscopes are adapted to measure the object's rate of rotation around the x, y, and z axes; and the magnetometers are adapted to measure the Earth's magnetic field strength in the x, y, and z directions. According to one embodiment of the description, the processor 110 can be adapted to use data captured by the IMU 132 to understand the autonomous robot's position and orientation in space. This information can then be used to control the robot's movement and to maintain its balance.

The precision localization module 115 can further comprise one or more monocular cameras 136 for visual odometry. The monocular camera 136 can be a 3D camera used to estimate the robot's motion by tracking features in the environment. The processor 110 can be adapted to use the visual odometry perceived by the monocular camera 136 to improve accuracy of localization and to compensate for drift in the GPS and IMU sensors 128, 132.

In some embodiments, the precision localization module 115 can also comprise a wheel odometry sensor 134 adapted to measure the robot's distance travelled. In one example, the wheel odometry sensor 134 can be implemented by attaching encoders to the autonomous robot's wheels. The processor 110 can be adapted to use data from the wheel odometry sensor 134 in conjunction with data captured from other sensors to provide a more accurate localization.

According to some embodiments of the description, the system 100 can include one or more red, green and blue (RGB) cameras 138 for pathway detection. For example, the system 100 can include one or more RGB cameras 138 at one or more of the front, rear, left, and right sides of the autonomous robot. The processor 110 can be adapted to use images captured by the RGB cameras 138 to identify walkways and other navigable areas in the environment. This information can be used to plan the robot's route and to avoid obstacles.

As will be explained in more detail below, the processor 110 can be adapted to use the various cameras and/or sensors 132, 134, 136, 138 to provide semantic segmentation and pathway detection for the autonomous robots to navigate safely and efficiently. In particular, the processor 110 can be adapted to provide semantic segmentation by classifying each pixel in an image into its corresponding semantic category, such as road, sidewalk, vegetation, buildings, or the like. The processor 110 can be further adapted to detect pathways or walkways which applies the semantic segmentation to identify and classify pathways within an image or scene.

The system 100 can further or alternatively comprise other types of depth cameras or perception sensors to be used in topological mapping and pathway identification. For example, the system 100 may include one or more first-person view (FPV) cameras or other types of depth camera which are adapted to infer the distance (or depth) of points in the scene from the camera.

The autonomous robots can utilize the cameras or sensors described above to perform topological mapping and pathway detection through a combination of image processing, computer vision, and machine learning techniques, as will be explained in more detail below.

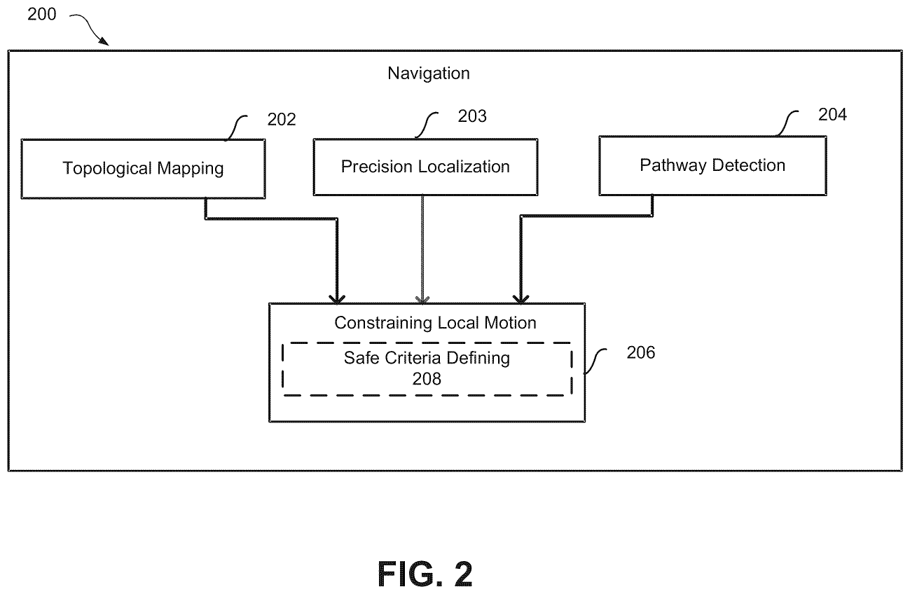

FIG. 2 shows a block diagram 200 of an automatous navigation process, according to one embodiment of the description.

According to the embodiment, an automatous navigation process comprises topological mapping 202 for creating a topological mapping (e.g., graph) of an area of environment around a location of the mobile robot. For the purposes of the description, a topological graph is a skeleton or simplified representation of a localized area. The topological mapping process 202 enables the autonomous robot to roughly identify where the robot is, and provides connectivity information between rooms, corridors, highways, pathways, etc., which can subsequently be used for navigation.

The automatic navigation process further comprises pathway detection or identification 204 for identifying at least one pathway around the location of the mobile robot. For the purposes of the description, the terms “pathway” and “walkway” can be used interchangeably.

The automatic navigation process can also include a precision localization process 203 utilizing the various components of the precision localization module 115 to assist in constraining the local motion.

The method 200 provides navigation of the autonomous robot by combining and integrating the topological mapping 202, the precision localization 203, and the pathway detection 204 together to enhance the robot's navigation capabilities. The topological mapping 202 can provide a global understanding of the environment, while pathway detection 204 can identify specific routes for navigation. When precision localization 203 is fully or partially lost in the process, the pathway detection 204 can prevent accidents or deviation from the route allowing the robot to navigate in all conditions. This combination can allow the robot to plan efficient paths and adapt to dynamic environments.

In various embodiments of the description, the navigation comprises a process of constraining local motion 206 for constraining a motion of the mobile robot locally based on the generated topological map or graph, the precision localization and the identified at least one pathway. The local motion constraining process 206 may comprise a process of generating 208 a safe criteria for navigation based upon analyzing data perceived through the one or more sensors 132, 134, 136, 138.

Using the simplified representation of the localized area generated through the topological mapping 202, the system 100 is expected to encounter inaccuracies in the precise positioning provided by the GNSS unit 128. However, the system 100 can accommodate the excepted inaccuracies through a local definition involving identifying pathways around the local area and constraining the autonomous robot locally to remain the robot on route. For example, the system can impose local accuracy constraints through the robot's perception sensors 132, 134, 136, 138 to keep the robot's motion within the route.

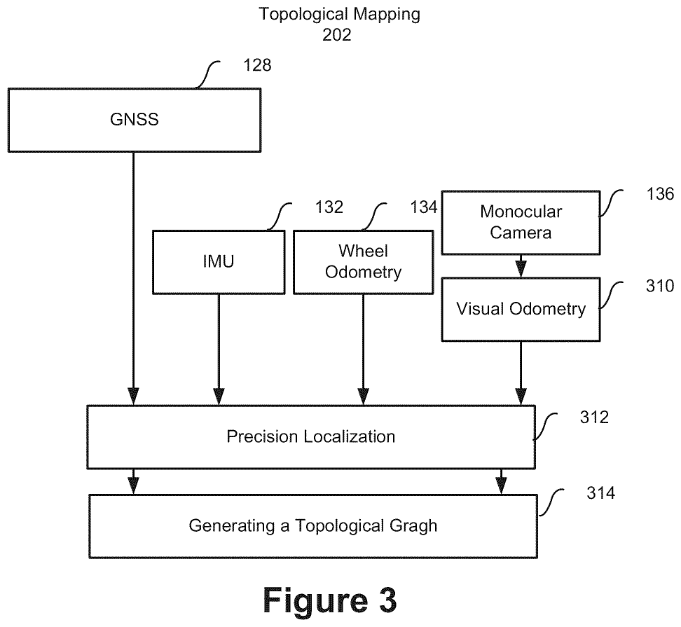

FIG. 3 shows a process of topological mapping 202, according to one embodiment of the description.

As described above, topological mapping 202 can create a simplified representation or skeleton of or around an environment of a local area, focusing on key landmarks and their relationships rather than precise measurements.

In one embodiment, the topological mapping process 202 comprises gathering location data of the robot from the GNSS unit 128 using e.g., the RTK GPS system.

The other components in the precision localization module 115 may also play an important role in this process including capturing images of the surroundings and using the images to extract relevant features.

In particular, the topological mapping process 202 can receive input from the IMU unit 132, the wheel odometry 134, and/or a visual odometry 310 obtained from images captured using the monocular camera 136. The process comprises a precision localization process 312 which involves identifying and extracting key features, such as corners, edges, distinctive objects, or the like captured by the monocular cameras 136 and matching them across different images to establish connections between landmarks. This can allow the system to build a network of interconnected landmarks.

The gathered GPS and other sensor data, the matched features and their relationships can be used through precision localization to generate 312 a topological graph. The generated topological graph is a skeleton of the area which represents the overall layout of the environment. This graph therefore provides a simplified representation of the environment's structure, highlighting key landmarks and their connections.

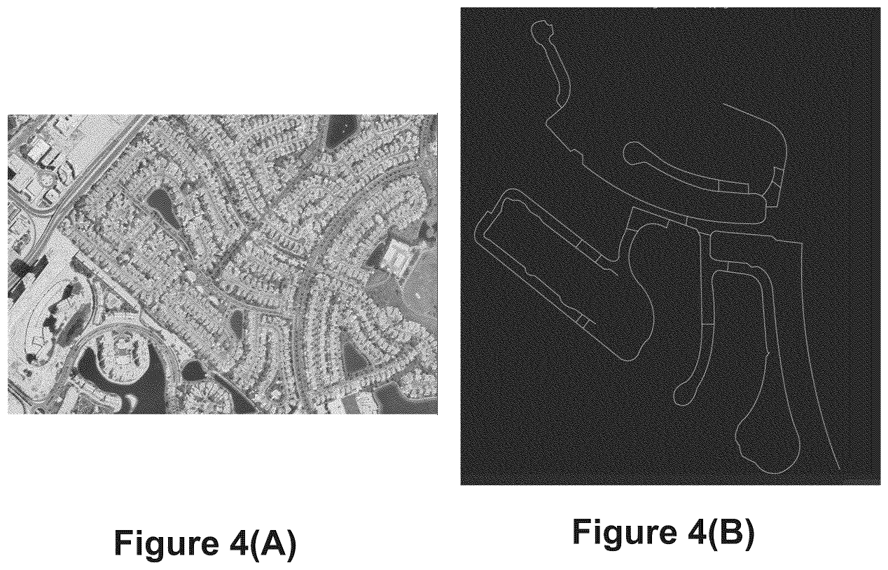

FIGS. 4A and 4B show examples of a topological map generated in accordance with an embodiment of the present description.

In contrast to the conventional methods which provides localization with a 2D or 3D dense mapping, the embodiments of the description generate a topological mapping of the area so the robot would know roughly where it is, the connectivity between different landmarks, and can use it in navigation.

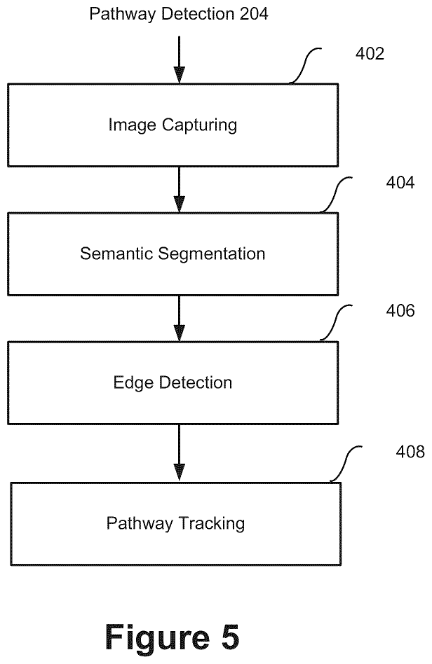

FIG. 5 shows a process of pathway detection 204, according to one embodiment of the description.

Pathway detection 204 can comprise identifying and tracking navigable paths within the environment. The one and more sensors in the system 100, for example, the depth camera 136, can also play an important role in this process 402 as they provide visual information about the surrounding terrain.

In particular, the process 204 can include capturing 402 one or more images of the environment by one or more of the sensors 136, 138.

The process 204 can further comprise a process of image or semantic segmentation 404 where the captured images are segmented to distinguish between different types of surfaces, such as roads, sidewalks, vegetation, and the like. This segmentation allows the robot to identify potential pathways.

The segmented images can then be used to apply 406 edge detection algorithms to identify continuous lines and boundaries, and to subsequently identify e.g., curbs, lane markings, or other pathway edges.

The process 204 can also comprise pathway tracking 408 where the detected edges and segmented surfaces are combined to track and follow pathways. The robot can use this information to navigate along the identified paths.

Other sensors of the system 100, such as the inertial measurement unit (IMU) 132 and wheel odometry 134 can also facilitate in the localization process of the navigation system 100. For example, the processor 110 use data from the wheel odometry sensor 134 in conjunction with data captured from other sensors to provide a more accurate localization.

According to various embodiments of the description, the method 200 of automatous navigation of a mobile robot can also use machine learning techniques, such as deep convolutional neural networks (CNNs), to improve the accuracy and robustness of topological mapping and pathway detection. CNNs can be trained on large datasets of images and their corresponding maps or pathways to learn the complex patterns and features that differentiate between different elements in the environment. This allows the robot to make more informed decisions about feature extraction 306, matching 308, and pathway tracking 408.

To navigate an environment, it is important for the autonomous robot to know its location as precisely as possible within the environment. In applications where a robot has to move from a predefined initial start position to an end position, a map would have to be built a priori which is used to localize itself during the navigation task. This has been performed in the past by generating dense grid maps represented as occupancy 2D or 3D maps (e.g., probabilistic occupancy maps or 3D point clouds, and the like). To generate these maps, a large amount of data has to be gathered, and extensive post-processing has to be performed to provide the final maps so that they are consistent globally and locally.

According to various embodiments of the description, the method of autonomous navigation relies on topological maps of the environment that capture the traversable routes. These maps can be generated by logging the robot's position as it traverses these routes and processing it offline to generate topological skeletal maps that could be used for online navigation. During navigation, the robot does not attempt to localize against the previously generated topological map but utilizes GNSS data fused with data from various sensors to estimate its global position. It is anticipated that inaccuracies will be present in this global position estimation. Still, during navigation, the robot's various perception sensors (e.g., RGB cameras 138 and the visual odometry camera 136) can be used to determine the traversable path (e.g., pathways, crosswalks, etc.) to constrain the robot's motion within them.

This approach can ensure that the robot continues local navigation safely while it recovers from any global positioning inaccuracies faced during challenging scenarios such as urban canyons. Unlike other methods/approaches deployed, the various embodiments according to the present description do not attempt to localize against maps but use these maps as navigational references to generate motion plans. In one embodiment of the description, the localization relies on an RTK GNSS solution that reduces drift by integrating various additional sensors (e.g., wheel odometry 134, cameras 136, 138, IMU 132, and RTK GPS 128). In some examples, the localization according to some examples can provide an accuracy within a few centimetres.

The method according to the embodiments of the description is therefore not aimed for obtaining an absolute position, but instead is targeted for a globally consistent and locally accurate position. From a global perspective, globally consistence refers to that the system will not aim to provide specificity in the area e.g., in the street, and the system is expected to face intermittent errors, e.g., a few meters offset. However, the system can recover from it because the system can provide local accuracy based on identified pathway(s), as well as the direction the robot is moving. This allows the system to cut the cost of the high definition sensors or high end hardware to ascertain the positioning.

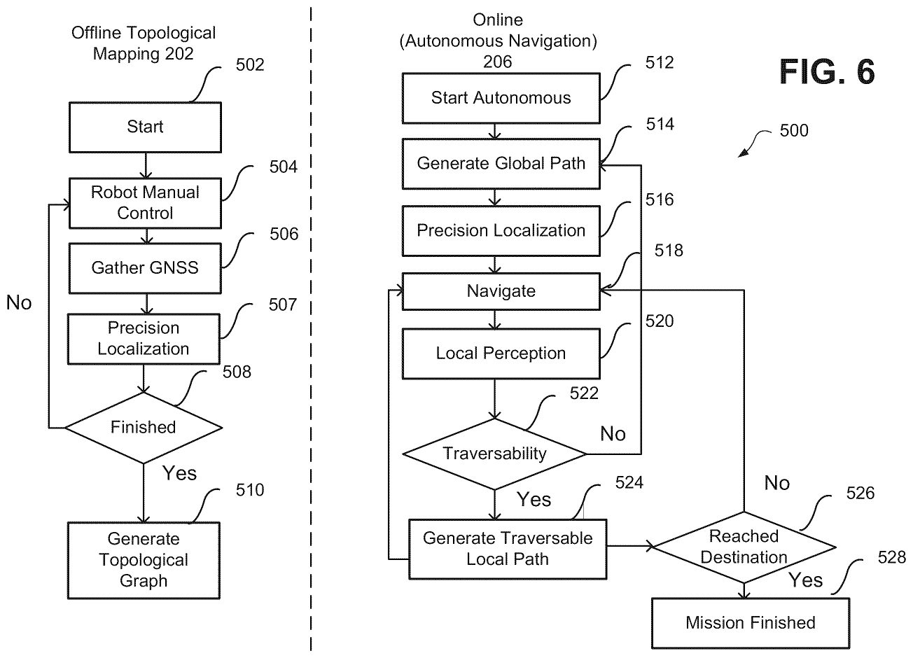

FIG. 6 illustrates a method 500 of automatous navigation of a mobile robot, e.g., a last mile delivery robot, according to one embodiment of the description.

As illustrated in FIG. 6, the system 100 can be adapted to perform topological mapping 202 offline and use the topological map to perform the autonomous navigation steps 206 online.

The navigation method starts at step (502) as the robot traverses a route e.g., during an environmental surveying. The system 100 may be adapted to access the at least one computer-readable memory/memories 122 to retrieve (504) data from a robot manual control. The method 500 further gathers (506) positioning data from the GNSS unit 128 to log the robot's position and perform precision localization (507). In one embodiment of the description as described above, the GNSS unit 128 can be a RTK GPS system. The process of retrieving (504), gathering (506), and precision localization (507) can be repeated until all necessary data have been gathered at step (508), which are subsequently used to generate (510) a skeleton topological graph for use in navigation.

In one embodiment of the description, this process is performed offline in order to limit the amount of data involved in processing and to improve efficiency. For example, there can be a large amount of readings coming into the navigation system 100 as the robot continues to move from one position to another, an offline filtering can provide a sufficient but not data intensive topological mapping of the area for the localization process. By way of an example, for an area of a few square kilometers the system 100 may have a simplified representation of a few tens of kilobytes, which is a small representation of the area compared to conventional methods.

The autonomous process may start online at step (512), where the generated topological graph is used to generate (514) a global path. The global path is fused (516) with data received from the precision localization module 115. The system 100 is adapted to use the generated global path and the precision localization for navigation (518) of the autonomous robot.

During localization process (520), the method 500 does not attempt to localize against the previously generated topological map but rather utilizes data and images captured through the one or more sensors 132, 134, 136, 138 to fuse with the GNSS positioning. In particular, the local perception (520) process can comprise, for example, a pathway detection 204 process as described above to determine a traversable path (e.g., pathways, crosswalks, etc.) which can be used to constrain the robot's motion within them.

The system 100 based on the detected traversable path can determine (522) whether the path is traversable and if it is, the system 100 is adapted to generate (524) a traversable local path. In one implementation, the system 100 may provide terrain traverserbility assistance to determine whether the robot can traverse on the identified pathway. By way of an example, when the robot approaches a curb the system 100 can be adapted to determine whether the robot can climb on the curb. If it is determined that the path is not traversable, the process will return to the step of generating (514) a global path in finding a new traversable local path.

If the robot has reached (526) its destination, the mission (e.g., a delivery mission) is considered finished (528). Otherwise, the method 500 reverts back to and continues through the process of navigation (518).

In accordance with the embodiment of the description, when a robot is to be deployed in the area, location data of the area can be gathered ahead of time and offline using the RTK GPS system. This data is then used to create a skeleton of the area without performing any dense mapping.

As explained above, the system 100 expects inaccuracies to happen for localization. However, the system recovers from the inaccuracies or constrain the motions of the robot based on the local environment captured and perceived by the at least one sensor 132, 134, 136, 138, to prevent accidents or deviation from the route.

For example, assuming the system 100 has a topological map (e.g., a skeleton of the pathways) of the area and if the autonomous robot is moving from one street to another and crossing an intersection, the topological map is first used to navigate. However, the system 100 at the same time can analyze the local space and identified pathway(s) to try to confine the motion of the robot within the pathway(s). In this way, even with the inaccuracies in the GPS positioning (for example, with an offset of one kilometer), the robot will not end up outside the local constraint.

In other words, the system 100 according to various embodiments of the description willingly takes the risk of localization inaccuracies but accommodates them through local definitions or perceptions to remain the robot on route.

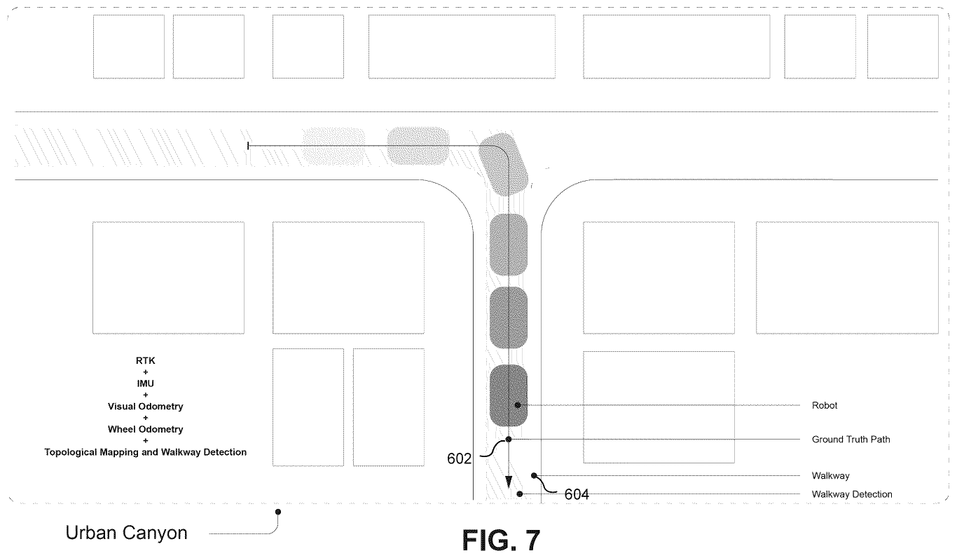

FIG. 7 provides an illustration of the mobile robot motion using a system and method according to some embodiments of the description. As can be seen from the figure, the system implemented with topological mapping and walkway detection can impose local accuracy constraints through the robot's perception sensors and keep the robot's motion within the walkway 604 along the ground truth path 602.

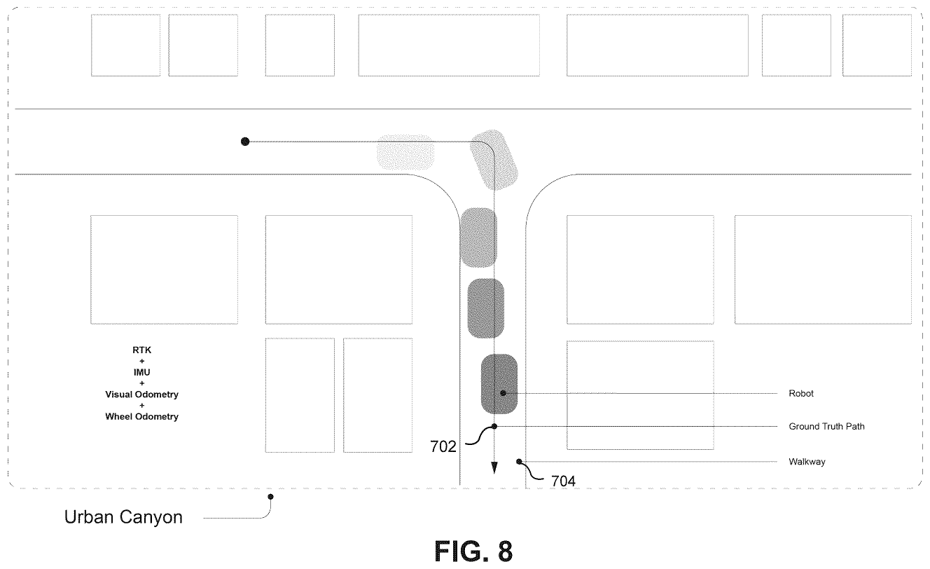

FIG. 8 provides an illustration of the mobile robot motion without using topological mapping or walkway detection. As can be seen from the figure the robot ends up deviating from its ground truth path 702 within urban canyons and does not restrict its motion within the walkway 704.

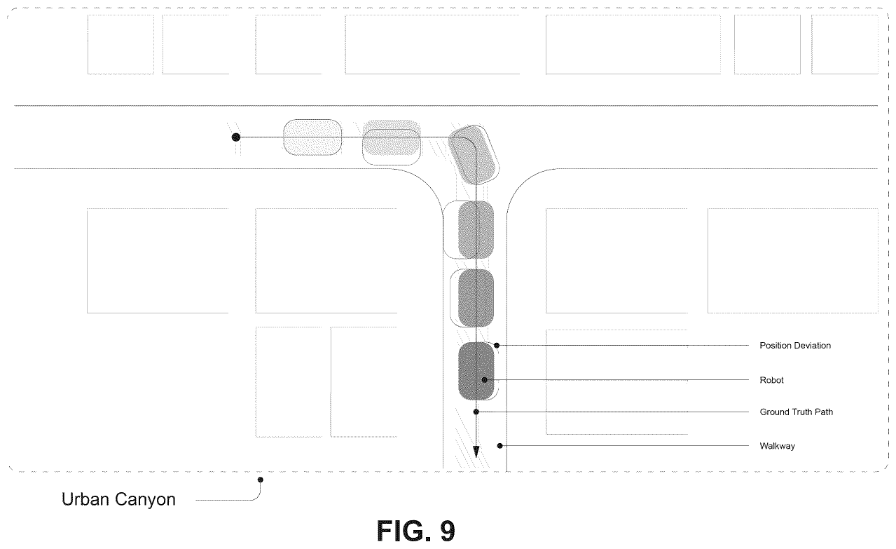

FIG. 9 is an illustration of the mobile robot motions of FIGS. 7 and 8 overlapped for comparison.

In contrast to conventional methods, the approach according to various embodiments of the description leverages global GNSS positioning while imposing local accuracy constraints based on data captured through the one or more robot's perception sensors 132, 134, 136, 138. It uses semantic scene understanding and pathway detection to navigate effectively within unexpected challenges and it handles intermittent global positioning inaccuracies by imposing motion constraints locally to ensure that motion commands are safe and continuous, and to facilitate recovery from positioning inaccuracies.

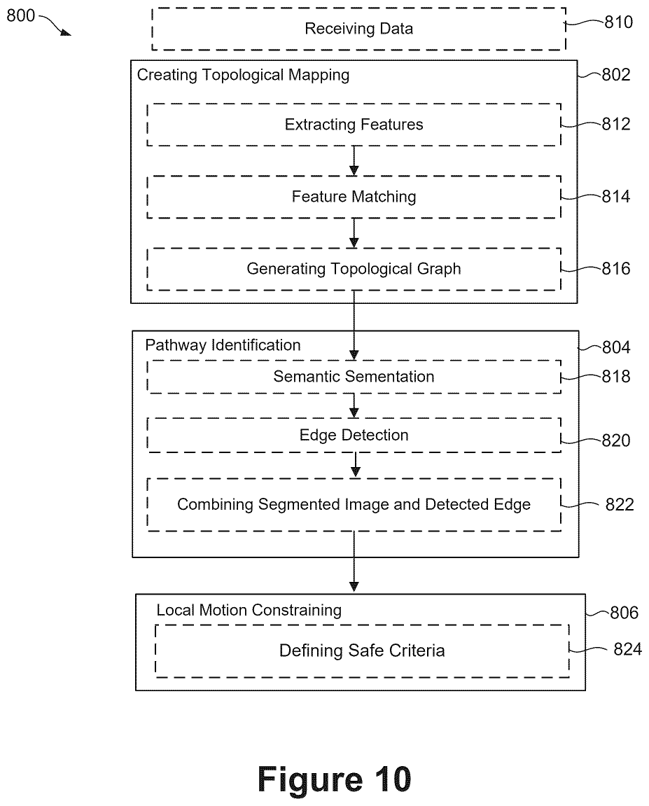

FIG. 10 is a flow diagram of a method 800 of autonomous navigation of a mobile robot, according to some embodiments of the description.

The method 800 comprises creating (802) a topological mapping of an area of environment around a location of the mobile robot; identifying (804) at least one pathway around the location; and locally constraining (806) a motion of the mobile robot based on the topological mapping and the identified at least pathway.

In some embodiments, the method 800 may further comprise receiving (810) data from one or more cameras and sensors attached to the mobile robot. The one or more cameras and sensors may include one or more of a monocular camera, a wheel odometry sensor, an IMU and a RGB camera.

In some embodiments, creating the topological mapping of the environment may further comprise receiving (810) data from a RTK GPS.

In some embodiments, the topological mapping of the area of environment may comprise a network of interconnected landmarks that includes one or more landmarks and a relationship between the one or more landmarks.

In some embodiments, creating (802) the topological mapping of the environment may further comprise extracting (812) features from images captured by one or more cameras and sensors; matching (814) the extracted features across different images to establish connections between landmarks; and generating (816) a topological graph using the matched features and the connections between the landmarks.

In some embodiments, identifying (804) the at least one pathway may further comprise semantic segmenting (818) an image captured by one or more cameras and sensors to classify each pixel in the image into a corresponding semantic category; detecting (820) edges in the segmented image to identify continuous lines and boundaries; and combining (822) the segmented image and the detected edges to identify the at least one pathway within the image as a route for navigation.

In some embodiments, locally constraining (806) the motion of the mobile robot may comprise defining (824) a safe criteria for robot motion commands based on the topological mapping and the identified at least pathway.

In some embodiments, an accuracy and robustness of the topological mapping and pathway identification may be improved using machine learning techniques.

The localization and navigation method according to various embodiments of the description can provide one or more of a number of advantages, including:

Cost Efficiency: Unlike the methods that rely on LiDAR-based localization methods, the approach according to various embodiments can be more cost-effective as it uses only depth cameras. The approach can significantly reduce the overall cost of deploying last-mile delivery robots, making them more accessible to a broader range of businesses and applications (the LiDAR is the most expensive component of autonomous vehicles).

Reduced Form Factor Limitations: By moving away from LiDAR, which often has bulkier form factors, the method according to various embodiments offers a more compact and versatile solution. This can make it easier to integrate into a variety of robot designs and reduce spatial constraints.

Navigation Robustness: By embracing and addressing positioning errors, the method according to various embodiments is designed to be more robust in real-world scenarios. This means the robot can adapt to unexpected challenges while still maintaining accurate localization.

Reduces the need for dense mapping: the approach according to various embodiments does not rely on dense mapping, and thus can reduce the effort and resources required to gather, clear and process the data offline and during online missions.

As can be seen from the above description, the system, method and non-transitory computer-readable storage device for autonomous navigation of autonomous robot described herein is directed to improving aspects of the computer-specific problem of handling precise localization and navigation and can address existing challenges associated with the size and efficiency of dense mapping of the operational environment.

While the various embodiments make reference to autonomous last mile delivery robots, it should be understood that the system and method of autonomous navigation can apply to various other outdoor or indoor autonomous robots include, but are not limited to, delivery robots, cleaning robots, construction robots, security robots, etc. The infusion of the approach in the form of a technology stack can provide a competitive advantage that will facilitate the commercialization of these systems.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g., “such as”) is intended merely to better illustrate or describe embodiments of the disclosure and is not intended to limit the scope of the disclosure unless otherwise claimed.

As used herein, the term “machine-readable medium,” “computer-readable medium,” or the like may refer to any component, device, or other tangible medium able to store instructions and data temporarily or permanently. Examples of such media may include, but are not limited to, random-access memory (RAM), read-only memory (ROM), buffer memory, flash memory, optical media, magnetic media, cache memory, other types of storage (e.g., Electrically Erasable Programmable Read-Only Memory (EEPROM)), and/or any suitable combination thereof. The term “computer-readable medium” should be taken to include a single medium or multiple media (e.g., a centralized or distributed database, or associated caches and servers) able to store instructions. The term “computer-readable medium” may also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “computer-readable medium” may refer to a single storage apparatus or device, as well as “cloud-based” storage systems or storage networks that include multiple storage apparatus or devices. The term “machine-readable medium” excludes transitory signals per se.

Although several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of autonomous navigation of a mobile robot, comprising:
creating a topological mapping of an area of environment around a location of the mobile robot;
identifying at least one pathway around the location; and
locally constraining a motion of the mobile robot based on the topological mapping and the identified at least pathway.

2. The method according to claim 1, further comprising receiving data from one or more cameras and sensors attached to the mobile robot, wherein the one or more cameras and sensors comprise one or more of a monocular camera, a wheel odometry sensor, an inertial measurement unit (IMU) and a red, green, and blue (RGB) camera.

3. The method according to claim 1, wherein creating the topological mapping of the environment comprises receiving data from a Real-Time Kinematic (RTK) Global Positioning System (GPS).

4. The method according to claim 1, wherein the topological mapping of the area of environment comprises a network of interconnected landmarks including one or more landmarks and a relationship between the one or more landmarks.

5. The method according to claim 1, wherein creating the topological mapping of the environment further comprises:
extracting features from images captured by one or more cameras and sensors;
matching the extracted features across different images to establish connections between landmarks; and
generating a topological graph using the matched features and the connections between the landmarks.

6. The method according to claim 1, wherein locally constraining the motion of the mobile robot comprises defining a safe criteria for robot motion commands based on the topological mapping and the identified at least pathway.

7. The method according to claim 1, wherein identifying the at least one pathway further comprises:
semantic segmenting an image captured by one or more cameras and sensors to classify each pixel in the image into a corresponding semantic category;
detecting edges in the segmented image to identify continuous lines and boundaries; and
combining the segmented image and the detected edges to identify the at least one pathway within the image as a route for navigation.

8. The method according to claim 1, further comprising improving an accuracy and robustness of the topological mapping and pathway identification using machine learning techniques.

9. A system for autonomous navigation of an autonomous robot, comprising:
at least one hardware processor; and
at least one non-transitory computer readable media that store instructions that when executed by the at least one hardware processor cause the at least one hardware processor to perform operations comprising:
creating a topological mapping of an area of environment around a location of the mobile robot using data from one or more perception sensors;
identifying at least one pathway around the location using the data from the one or more perception sensors; and
locally constraining a motion of the mobile robot based on the topological mapping and the identified at least pathway.

10. The system according to claim 9, wherein the one or more perception sensors comprise one or more of a monocular camera, a wheel odometry, an inertial measurement unit (IMU) and a red, green, and blue (RGB) camera.

11. The system according to claim 9, wherein creating the topological mapping of the area of environment comprises receiving data from a Real-Time Kinematic (RTK) Global Positioning System (GPS).

12. The system according to claim 9, wherein the topological mapping of the area of environment comprises a network of interconnected landmarks including one or more landmarks and a relationship between the one or more landmarks.

13. The system according to claim 9, wherein creating the topological mapping of the environment further comprises:
extracting features from images captured by the one or more perception sensors;
matching the extracted features across different images to establish connections between landmarks; and
generating a topological graph using the matched features and the connections between the landmarks.

14. The system according to claim 9, wherein locally constraining the motion of the mobile robot comprises defining a safe criteria for robot motion commands based on analyzing the data from the one or more perception sensors.

15. The system according to claim 9, wherein identifying the at least one pathway further comprises:
semantic segmenting an image captured by the one or more perception sensors to classify each pixel in the image into a corresponding semantic category;
detecting edges in the segmented image to identify continuous lines and boundaries; and
combining the segmented image and the detected edges to identify the at least one pathway within the image as a route for navigation.

16. The system according to claim 9, wherein the operations further comprise improving an accuracy and robustness of the topological mapping and pathway identification using machine learning techniques.

17. One or more non-transitory computer-readable storage devices comprising computer-executable instructions, wherein the instructions, when executed, cause one or more hardware processors to perform a method of autonomous navigation of a mobile robot, the method comprising:
creating a topological mapping of an area of environment around a location of the mobile robot;
identifying at least one pathway around the location; and
locally constraining a motion of the mobile robot based on the topological mapping and the identified at least pathway.

18. The one or more non-transitory computer-readable storage devices according to claim 17, wherein creating the topological mapping of the environment further comprises:
extracting features from images captured by the one or more cameras and sensors;
matching the extracted features across different images to establish connections between landmarks; and
generating a topological graph using the matched features and the connections between the landmarks.

19. The one or more non-transitory computer-readable storage devices according to claim 17, wherein identifying the at least one pathway further comprises:
semantic segmenting an image captured by one or more cameras and sensors to classify each pixel in the image into a corresponding semantic category;
detecting edges in the segmented image to identify continuous lines and boundaries; and
combining the segmented image and the detected edges to identify the at least one pathway within the image as a route for navigation.

20. The one or more non-transitory computer-readable storage devices according to claim 17, wherein locally constraining the motion of the mobile robot comprises defining a safe criteria for robot motion commands based on the topological mapping and the identified at least pathway.
